(19) United States
(12) Patent Application Publication
(10) Pub. No.: US 2011/0153663 A1
(43) Pub. Date: Jun. 23, 2011

(54) RECOMMENDATION ENGINE USING IMPLICIT FEEDBACK OBSERVATIONS

(75) Inventors: Yehuda Koren, Elizabeth, NJ (US); Yifan Hu, Mountain Lakes, NJ (US); Christopher T. Volinsky, Morristown, NJ (US)

(73) Assignee: AT&T INTELLECTUAL PROPERTY I, L.P., Reno, NV (US)

(21) Appl. No.: 12/643,237

(22) Filed: Dec. 21, 2009

(51) Int. Cl. G06F 17/30

(52) U.S. Cl. 707/776; 707/E17.039

(57) ABSTRACT

Systems and methods to provide a recommendation engine that uses implicit feedback observations are provided. A particular method includes receiving accessing data comprising a plurality of implicit feedback observations for a plurality of users. The plurality of users includes a first user that requested a recommendation. Each implicit feedback observation is associated with a particular user and a particular item of a plurality of items. The method includes determining a plurality of preference ratings and a plurality of confidence ratings for each user of the plurality of users for each item based on the plurality of implicit feedback observations. The method includes generating a recommendation list of one or more of the plurality of items for the first user based on the plurality of preference ratings and the plurality of confidence ratings.

### FIELD OF THE DISCLOSURE

The present disclosure is generally related to a recommendation engine that uses implicit feedback observations.

### BACKGROUND

Recommender systems rely on different types of input. One type of input is high quality explicit feedback. Explicit feedback is information provided by users regarding their interest in products. For example, video services providers, such as Netflix®, collect star ratings for movies and providers of personal, interactive television programming systems, such as TiVo®, indicate their preferences for TV shows by thumbs-up or down buttons. However, explicit feedback is not always available. This may reflect reluctance of users to rate products or limitations of systems that are unable to collect explicit feedback. Some recommender systems also incorporate implicit feedback. Implicit feedback indirectly reflects user opinion by observing user behavior.

Recommender systems may use neighborhood models. A type of neighborhood model recommender system implements user-oriented methods to estimate unknown ratings based on recorded ratings of like minded users. Another type of neighborhood model recommender system uses item-oriented methods to estimate unknown ratings for a particular user based on known ratings made by the same user on similar items. Some recommender systems rely on past user behavior without requiring the creation of explicit feedback input. The recommender systems can infer user preferences from past user behavior.

Recommender systems may also use latent factor models. Latent factor models try to emphasize latent features that explain observed ratings. One type of latent factor model that has gained popularity is a Singular Value Decomposition (SVD) model. The SVD model uses a user-item observation matrix. The results of SVD models tend to be superior to the results of neighborhood models.

### BRIEF DESCRIPTION OF THE DRAWINGS

FIG. 1 a block diagram of a communication system that includes a recommendation engine that uses implicit feedback observation.

FIG. 2 is a flow diagram of a particular embodiment of a method of processing implicit feedback observation data in order to generate recommendations.

FIG. 3 is a graph comparing the results of recommendations from a recommendation engine using a factor model with the results of recommendations based on a popularity model and with the results of recommendations based on a neighborhood model.

FIG. 4 is a graph showing a cumulative distribution function of the probability that a show watched in the test set falls within top x % of recommended shows for several different models.

FIG. 5 is a graph depicting the performance of the recommendation engine using the factor model based on show popularity and based on user watching times.

FIG. 6 is a block diagram of an illustrative embodiment of a general computer system.

### DETAILED DESCRIPTION

In a particular embodiment, a method includes receiving, at a computing device, a request from a communication device of a first user for at least one recommendation. The method includes accessing, at the computing device, data comprising a plurality of implicit feedback observations for a plurality of users. The plurality of users includes the first user. Each implicit feedback observation is associated with a particular user and a particular item of a plurality of items. The method includes determining a plurality of preference ratings and a plurality of confidence ratings for each user of the plurality of users for each item based on the plurality of implicit feedback observations at the computing device. The method includes generating a recommendation list of one or more of the plurality of items for the first user based on the plurality of preference ratings and the plurality of confidence ratings. The method also includes sending the recommendation list to the communication device.

In a particular embodiment, a computer device includes a processor configured to receive a request via a communication device for at least one recommendation of an item for a first user associated with the communication device. The computer device includes a memory accessible to the processor. The memory includes a recommendation engine executable by the processor to receive data comprising a plurality of implicit feedback observations. Each implicit feedback observation is associated with a user of a plurality of users and an item of a plurality of items. The plurality of users includes the first user. The recommendation engine is executable by the processor to determine a plurality of preference ratings and a plurality of confidence ratings based on the plurality of implicit feedback observations. The recommendation engine is also executable by the processor to generate a recommendation list of one or more of the plurality of items for the first user based on the plurality of preference ratings and the plurality of confidence ratings.

In a particular embodiment, a computer-readable storage medium includes instructions, that when executed by a computer, cause the computer to receive data comprising a plurality of implicit feedback observations. Each implicit feedback observation is associated with a user of a plurality of users and an item of a plurality of items. The computer-readable storage medium includes instructions, that when executed by the computer, cause the computer to determine a plurality of preference ratings and a plurality of confidence ratings based on the plurality of implicit feedback observations. The computer-readable storage medium also includes instructions, that when executed by the computer, cause the computer to generate a recommendation of one or more of the plurality of items with respect to a particular user based on the plurality of preference ratings and the plurality of confidence ratings.

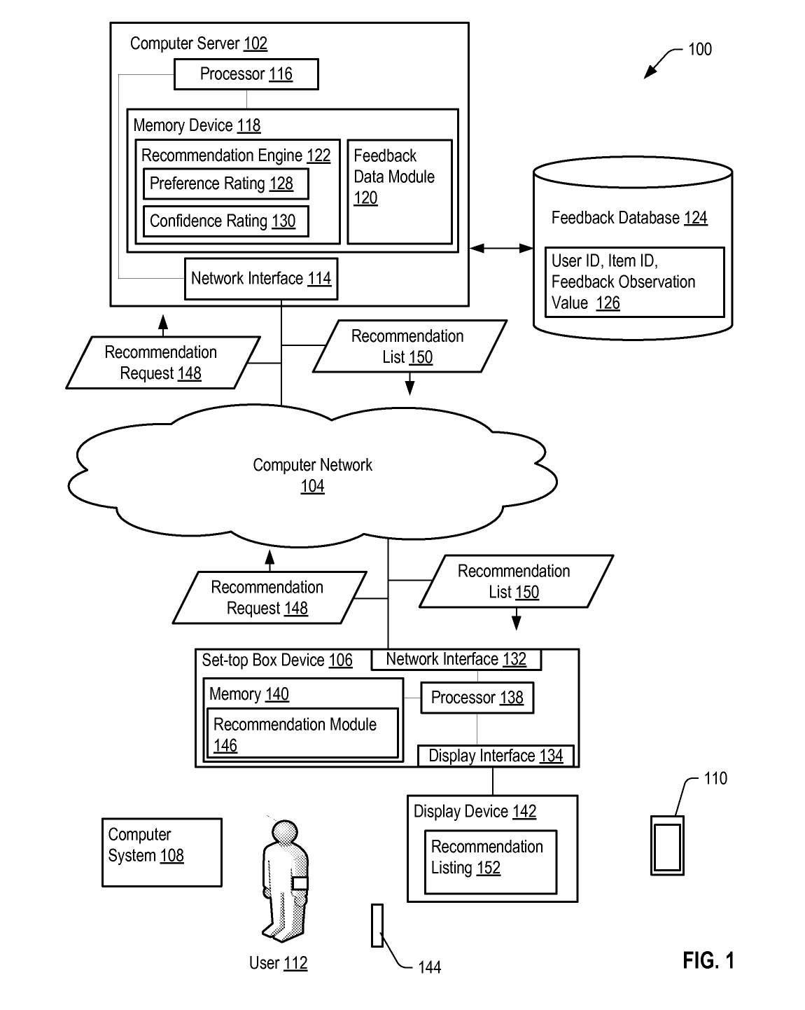

Referring to FIG. 1, a block diagram of a communication system that includes a recommendation engine that uses implicit feedback observation is depicted generally as 100. The communication system 100 may include a computer server 102 coupled via a computer network 104 to one or more communication devices 106-110 associated with a user 112. The communication devices 106-110 may include a set-top box device 106, a computer system 108 (e.g., a personal computer (PC), a laptop, or other type of electronic device that includes computer functionality), and a mobile communication device 110 (e.g., a personal digital assistant (PDA), a smart phone, or a cellular phone). Three communication devices 106-110 associated with the user 112 are depicted in FIG. 1, but fewer or more communication devices may be associated with the user 112. Other users may also have access to the computer server 102 via communication devices. The computer server 102 may be accessed by users of services provided by a service provider, such as the user 112. The service provider may provide access to the computer network 104 (e.g., the internet, a wireless communications network (e.g. a cellular phone network), a cable network, an internet protocol television (IPTV) network, a satellite network, or combinations thereof.

The computer server 102 may include a network interface 114 that is used to couple the computer server 102 to the computer network 104. The computer server 102 may also include a processor 116 and a memory 118. The memory 118 may include a feedback data module 120 and a recommendation engine 122. The feedback data module 120 may monitor behavior of a plurality of users, including the user 112, to obtain implicit feedback data. The feedback data module 120 may include instructions executable by the processor 116 to monitor viewing history, purchase history, browsing history, search patterns, mouse movement, keyboard usage, remote control usage, other usage patterns, or combinations thereof related to particular items. The items may be television programs, media content, consumer products, or combinations thereof. For example, the feedback data module 120 may include instructions executable by the processor 116 to monitor usage of the communication devices 106-110 to access and view television programs. In some embodiments, the feedback data module 120 may also receive explicit feedback from users.

The feedback data module 120 may include instructions executable by the processor 116 to determine numerical values for implicit feedback observations related to the users. The feedback data module 120 may include instructions executable by the processor 116 to store entries, including explicit feedback and including the numeric values for implicit feedback observations, in a feedback database 124. In some embodiments, the feedback database 124 may be a part of the memory 118 of the computer server 102. Data entries stored in the feedback database 124, as represented by a data entry 126, may include a user identification, an item identification, and an feedback observation value.

When the feedback data module 120 receives an implicit feedback observation for a particular user and a particular item, the feedback data module 120 may query the feedback database 124 for a particular data entry corresponding to the particular user and the particular item. When the particular data entry does not exist, the feedback data module 120 creates a new data entry and sends the new data entry to the feedback database 124. When the particular data entry exists, the feedback data module 120 may update the particular entry with the new observation and send the modified data entry back to the feedback database 124. For example, when the item is a television program and the implicit feedback observation is that the user 112 has viewed an episode of the television program, the feedback data module 120 queries the feedback database 124 to see if the user 112 has previously viewed the television program. When the user 112 has previously viewed the television program, the feedback data module 120 retrieves the previous entry, modifies the feedback observation value from the feedback database 124 with the new implicit feedback observation to create a modified entry, and sends the modified entry back to the feedback database 124. When the user 112 has not previously viewed the television program, the feedback data module 120 creates a new entry in the feedback database 124 and sends the new entry to the feedback database 124. For a new explicit feedback observation entry that already has a corresponding feedback observation value in the feedback database 124, the feedback data module 120 may replace the previous feedback observation value with the new feedback observation entry, or the feedback data module may create a new value based on the new feedback observation entry and the previous feedback observation value from the feedback database 124 (e.g., the implicit feedback data module 120 may create an average value).

The recommendation engine 122 may include instructions executable by the processor 116 to perform recommendation engine functionality. The recommendation engine 122 may generate or have access to preference ratings 128 and confidence ratings 130.

The set-top box device 106 may include a network interface 132, a display interface 134, a processor 138, and a memory 140. The user 112 may use a remote control device 144 to control the set-top box device 106. The network interface 132 may couple the set-top box device 106 to the computer network 104 so that the set-top box device 106 is able to communicate with the computer server 102. The network interface 132 may also allow other communication devices (e.g., computer system 108 and mobile communication device 110) to be coupled to the set-top box device 106 via the computer network 104 or via a local area network (LAN). The other communication devices may communicate directly with the computer server 102 via the computer network 104 or may communicate with the computer server 102 via the set-top box device 106.

The display interface 134 may couple the set-top box device 106 to a display device 142. The display device 142 may be a television, a computer monitor, or a similar type of viewing device.

The memory 140 of the set-top box device 106 may include data and instructions. The instructions may include recommendation module 146 that is executable by the processor 138. The processor 138 may receive a request for a recommendation of at least one item from the user 112 via the remote control device 144 or other input device. The processor 138 may execute instructions of the recommendation module 146 to send a recommendation request 148 to the computer server 102 via the computer network 104.

The processor 116 of the computer server 102 may receive the recommendation request 148 from the set-top box device 106. The processor 116 may execute instructions in the recommendation engine 122 to generate a list of one or more recommended items for the user 112 associated with the set-top box device 106 that sent the recommendation request 148. To provide the list of one or more recommended items, the recommendation engine 122 may request and receive data from the feedback database 124. The data may include feedback observation values. Each feedback observation value may be associated with a particular user of a plurality of users and a particular item of a plurality of items (e.g. television programs or video files). The retrieved feedback observation values may include implicit feedback observation values associated with the user 112, or implicit feedback observation values associated with the user 112 and explicit feedback observation values associated with the user 112.

The recommendation engine 122 is executable by the processor 116 to determine a plurality of preference ratings 128 and confidence ratings 130 for each of the plurality of users for each of the plurality of items. For each user u and each item i, the feedback observation value is rᵤᵢ. The preference rating 128 for a particular user and a particular item, pᵤᵢ, may be set to one for a particular item when there is a feedback observation value for the particular item from the particular user or may be set to zero when there is no feedback observation value for the particular item from the particular user. This may be expressed as:

$${p}_{ui} = \{ \begin{matrix}1 & {r}_{ui} > 0 \\ 0 & {r}_{ui} = 0\end{matrix} \qquad ( Eq . 1 )$$

In other words, if a user u consumed item i (rᵤᵢ>0), then there is an indication that u likes i (pᵤᵢ=1). On the other hand, if u never consumed i, there is no indication of a preference (pᵤᵢ=0). The preference ratings 128 are associated with varying confidence levels. In some embodiments, other values for pᵤᵢ may also be used. For example, a pᵤᵢ value of 0.5, 0.25, or another value may be assigned when certain conditions are met.

The zero values of pᵤᵢ are associated with low confidence, as not taking any positive action on an item can stem from many other reasons beyond not liking it. For example, the user 112 might be unaware of the existence of the item, or unable to consume the item due to its price or limited availability. In addition, consuming an item can also be the result of factors different from preferring it. For example, the user 112 may watch a television show just because the user 112 is staying on the channel of the previously watched show. Or the user 112 user may buy an item as a gift for someone else, despite not liking the item. Therefore, there may be different confidence levels among items that are indicated to be preferred by the user 112.

Because of the different confidence levels, the confidence rating 130 for a particular user relative to a particular item, cᵤᵢ, may be calculated. In general, a large value for the feedback observation value is an indication that the user 112 likes the item. Values of cᵤᵢ may indicate confidence in the preference rating 128. A choice of cᵤᵢ may be:

cᵤᵢ=1+arᵤᵢ (Eq. 2)

The rate of increase is controlled by the constant α. In some embodiments, the value of α may be set to 40. Another equation that can be used to calculate cᵤᵢ values is:

cᵤᵢ=1+α log(1+rᵤᵢ/ε) (Eq. 3)

Where ε is a constant (e.g., ε=10⁻⁸). In an embodiment, the rᵤᵢ value is an indication of a number of viewing units or viewing time of item i by user u.

Using Eq. 2 or Eq. 3 may provide a confidence value for every user-item pair. The confidence value may have a minimum value and may increase with increasing feedback observation value.

The recommendation engine 122 may find a vector xᵤε [symbol] ^{f} for each user u (where f is the number of latent factors), and a vector yᵢε [symbol] ^{f} for each item i that will factor user preferences. In other words, preferences are assumed to be the inner products: pᵤᵢ=xᵤ^{T}yᵢ. These vectors will be known as the user-factors and the item-factors, respectively. Essentially, the vectors strive to map users and items into a common latent factor space where they can be directly compared. Optimization should account for all possible u, i pairs, rather than only those corresponding to observed data. Accordingly, factors are computed by minimizing the following cost function:

min_{x*,y*}Σ_{u,i}cᵤᵢ(pᵤᵢ−xᵤ^{T}yᵢ)²+λ(Σᵤ∥xᵤ∥²+Σᵢ∥yᵢ∥²) (Eq. 4)

The λ(Σᵤ∥xᵤ∥²+Σᵢ∥yᵢ∥²) term is necessary for regularizing the model such that it will not overfit the training data. Exact value of the parameter λ is data-dependent and determined by cross validation.

The cost function of Eq. 4 contains m·n terms, where m is the number of users and n is the number of items. For typical datasets m·n can easily reach a few billion. This huge number of terms may prevent the use of many direct optimization techniques, such as stochastic gradient descent. An alternative technique may be used.

A first step is to recompute all user-factors. Assume that all item-factors are gathered within an n×f matrix Y. Before looping through all users, a f×f matrix Y^{T}Y may be computed in time O(f²n). For each user u, define the diagonal n×n matrix C^{u} where Cᵢᵢ^{u}=cᵤᵢ, and also the vector p(u)ε [symbol] ⁿ that contains all the preferences by u (the pᵤᵢ values). By differentiation, an analytic expression for xᵤ that minimizes the cost function Eq. 4 may be found. The analytic expression is:

xᵤ=(Y^{t}C^{u}Y+λI)⁻¹Y^{T}C^{u}p(u) (Eq. 5)

A computational bottleneck here is computing Y^{T}C^{u}Y, whose naive calculation will require time O(f²n) (for each of the m users). A significant speedup is achieved by using the fact that Y^{T}C^{u}Y=Y^{T}Y+Y^{T}(C^{u}−I)Y. Now, Y^{T}Y is independent of u and was already precomputed. As for Y^{T}(C^{u}−I)_{Y}, notice that C^{u}−I has only nᵤ non-zero elements, where nᵤ is the number of items for which rᵤᵢ>0 and typically nᵤ<<n. Similarly, C^{u}p(u) contains just nᵤ nonzero elements. Consequently, recomputation of xᵤ is performed in time O(f²nᵤ+f³). Here, assume O(f³) time for the matrix inversion (Y^{T}C^{u}Y+λI)⁻¹, even though more efficient algorithms exist, but probably are less relevant for the typically small values of f. This step is performed over each of the m users, so the total running time is O(f²N+f³m), where N is the overall number of non-zero observations, that is N=Σᵤnᵤ. Importantly, running time is linear in the size of the input. Typical usable values off may be between 20 and 200.

A recomputation of the user-factors is followed by a recomputation of all item-factors in a parallel fashion. All user-factors are arranged within an m×f matrix X. An f×f matrix X^{T}X may be computed in time O(f²m). A diagonal m×m matrix Cⁱ is defined for each item i, where Cᵤᵤⁱ=cᵤᵢ. Also used is the vector p(i)ε [symbol] ^{m} that contains all the preferences for i. The equation for yᵢ becomes:

yᵢ=(X^{T}CⁱX+λI)⁻¹X^{T}Cⁱp(i) (Eq. 6)

Using the same technique as with the user-factors, running time of this step would be O(f²N+f³n). A few sweeps of paired recomputation of user-factors and item-factors may be performed until they stabilize. A typical number of sweeps may be about 10. The whole process scales linearly with the size of the data. After computing the user-factors and item-factors, K available items with the largest value of \hat{p}ᵤᵢ=xᵤ^{T}yᵢ, where \hat{p}ᵤᵢ symbolizes the predicted preference of user u for item i, may be provided as recommendations.

In addition to providing the recommendations, the recommendation engine 122 may be accompanied by data that explains why particular recommendations were made. Such information may helps to improve trust in the ability of the recommendation engine 122 and may put recommendations in perspective. The predicted preference of user u for item i, \hat{p}ᵤᵢ=yᵢ^{T}xᵤ, becomes: yᵢ^{T}(Y^{T}C^{u}Y+λI)⁻¹Y^{T}C^{u}p(u). This expression can be simplified by introducing some new notation. The f×f matrix (Y^{T}C^{u}Y+λI)⁻¹ is denoted Wᵤ, which should be considered as a weighting matrix associated with user u. Accordingly, the weighted similarity between items i and j from u's viewpoint is denoted by sᵢⱼ^{u}=yᵢ^{T}Wᵤyⱼ. Using this new notation the predicted preference of u for item i is rewritten as:

\hat{p}ᵤᵢ=Σ_{j:r}_{ᵤⱼ}_{>0}sᵢⱼ^{u}cᵤⱼ (Eq. 7)

This is a linear model that predicts preferences as a linear function of past actions (rᵤⱼ>0), weighted by item-item similarity. Each past action receives a separate term in forming the predicted \hat{p}ᵤᵢ, and thus the unique contributions can be isolated. The actions associated with the highest contribution are identified as the major explanation behind the recommendation. In addition, the contribution of each individual past action may be broken into two separate sources: the significance of the relation to user u, and the similarity to target item i.

Determining the source of the recommendation and a numeric value for the contribution using Eq. 7 may involve solving a linear system (Y^{T}C^{u}Y+/λI)⁻¹yⱼ, followed by a matrix vector product, and can be done in time O(f²nᵤ+f³), assuming that Y^{T}Y is precomputed.

The recommendation engine 122, based on the preference ratings 128 and the confidence ratings 130, is configured to generate a recommendation list 150 of one or more of the plurality of items for the user 112 in response to the recommendation request 148 from the user 112. The recommendation list 150 may be generated based on the plurality of preference ratings 128 and the plurality of confidence ratings 130 for multiple items and for multiple users, where the user 112 is included as one of the multiple users. In a particular embodiment, the plurality of items comprises television programs. For example, television programs may include So You Think You Can Dance?, Hell's Kitchen, Judge Judy, Moment of Truth, Don't Forget the Lyrics, or other television programs available to the user 112 via the set-top box device 106, the computer system 108, via over-the-air broadcast reception received by the display device 142, or otherwise receivable by the user 112. A recommendation list for a user who has access to the computer server 102 other than the user 112 may also be prepared by the computer server 102 when the computer server 102 has gathered feedback observation data for such a user.

The recommendation engine 122 is executable by the processor 116 to create the recommendations list 150 in response to the recommendation request 148 from the user 112. The processor 116 may send the recommendation list 150 to the set-top box device 106. The set-top box device 106 may store the recommendation list 150 in the memory 140 and send the recommendation list 150 to the display device 142 for viewing as a recommendation listing 152.

The above-description describes the set-top box device 106 sending the recommendation request 148 to the computer server 102. Another communication device (e.g., computer system 108 or mobile communications device 110) associated with the user 112 may also be used to send a recommendation request to the computer server 102 and to receive a recommendations list 150 from the computer server 102.

The recommendation engine 122 may generate the recommendations list 150 to provide a personalized recommendation to a user, such as the representative user 112. The recommendation engine 122 may generate the recommendation list based on feedback received by the computer server 102 for the user 112 and other users. The recommendation engine 122 may generate the recommendation list based on items that the user 112 has experienced and based on items that the other users have experienced. In some embodiments, the feedback does not include any explicit feedback from the user 112 or any of the other users. The recommendation engine 122 within the computer server 102 may passively track different sorts of user behavior such as purchase history, viewing habits, and internet browser activity in order to model user preferences from implicit feedback. Thus, the recommendation engine 122 may estimate preferences and confidence values based on implicit feedback data. The feedback observation data may be evaluated to identify positive and negative preferences associated with vastly varying confidence levels. This leads to a factor model that is tailored for implicit feedback recommendations. The system may also provide a scalable optimization procedure that scales linearly with the data size. Thus, a computer program may be efficiently used to generate recommendation lists for a large number of users. The recommendation engine 122 is suitable for use with video data such as television programs. Thus, an enhanced recommendation engine that is accessible to a large variety of user devices and a large number of users via a computer network has been described.

In some embodiments, the recommendation engine 122 may use explicit feedback or both implicit feedback and explicit feedback. For example, available explicit data may be video ratings based on a scale from 1 to 5, with 5 being the highest rating. A rating of 5 could be translated to a preference rating of 1 and a very large confidence rating, while a rating of 3 could be translated to a preference rating of 0.5 and a large confidence rating. The other rating values may be similarly translated to preference ratings and confidence ratings. Other suitable preference ratings and confidence ratings may be used to express explicit data or combinations of explicit data with implicit data.

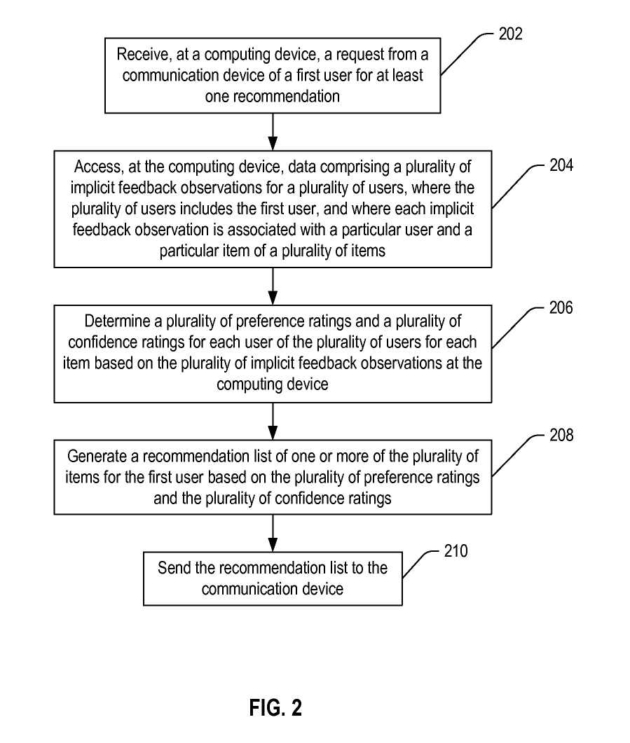

Referring to FIG. 2, a particular embodiment of a method of processing implicit feedback observation data in order to generate recommendations is shown. The method includes receiving a request from a communication device of a first user for at least one recommendation, at 202. The request may be received at a computing device. For example, the recommendation request 148 depicted in FIG. 1 may be received by the computer server 102 depicted in FIG. 1. The method further includes accessing data at the computing device where the data comprises a plurality of implicit feedback observations for a plurality of users, at 204. The plurality of users includes a first user. Each implicit feedback observation is associated with a particular user and a particular item of a plurality of items. For example, a plurality of records within the feedback database 124 depicted in FIG. 1 may each identify a particular user, a particular item, and a particular feedback observation value. The method further includes determining a plurality of preference ratings and a plurality of confidence ratings for each user of the plurality of users and for each item based on the plurality of implicit feedback observations at the computing device, at 206. The method further includes generating a recommendation list of one or more of the plurality of items for the first user, at 208. The recommendation list may be generated based on the plurality of preference ratings and the plurality of confidence ratings. The method further includes sending the recommendation list to the communication device, at 210.

In a particular illustrative embodiment, the plurality of preference ratings and the plurality of confidence ratings are determined without considering any explicit feedback observations. In addition to the implicit feedback observations for users and items, certain items may not have any associated implicit feedback data. In this case, a default value may be provided for the preference ratings and the confidence ratings. As a particular example, a preference rating value of zero may be provided and a low confidence value (e.g., a value of 1) may be provided. In this situation, no preference is indicated and a low confidence value is used for the item not having any associated implicit feedback data. Thus, even items not associated with implicit feedback data may be evaluated by the recommendation engine to determine the recommendation item list.

In a particular illustrative embodiment, the plurality of implicit feedback observations may include one or many quantified sets of data. For example, the implicit feedback observations may include quantifications of viewing patterns (e.g., for videos) or listening patterns (e.g., for music) of one or more of the plurality of items for each user of the plurality of users. Alternatively, the plurality of implicit feedback observations may include quantifications of searching patterns relevant to one or more of the plurality of items for each of the plurality of users. In a particular example, the searching patterns include at least one of remote control use, computer mouse movement, and keyboard manipulations attributable to each of the plurality of items. The plurality of implicit feedback observations may further include quantifications of browsing history attributable to one or more of the plurality of items for each of the plurality of users. In addition, the plurality of implicit feedback observations may include quantifications of purchasing history attributable to one or more of the plurality of items for each of the plurality of users. The purchasing history may include rental activity and purchase to own activity, as examples. The plurality of items suitable for recommendation include media content items such as video on demand items, broadcast items, and television programs.

In a particular illustrative embodiment, the plurality of implicit feedback observations includes indications of how long a selected user interacted with a selected item. As a further example, the plurality of implicit feedback observations may include indications of how many separate times a selected user interacted with a selected item.

In a particular embodiment, the recommendation list, such as the recommendation list 150 depicted in FIG. 1, may include data for at least one item in the recommendation list that is influenced by a selection of a particular item in the recommendation list. For example, a particular item in a recommendation list may be influenced by implicit observation data associated with a different recommendation item. A display may show both the particular recommendation item and the influencing items in a common display view. A further example of a display of such items is presented in Table 1 below. It should be understood that the recommendation engine and the recommendation list may be generated by a processor programmed by software stored within a memory where the software is executable by the processor to perform the disclosed functions described herein related to recommendation list generation.

### Example

An analysis was performed on data from a digital television service. A training set of data was collected during a four week period for about 300,000 set top boxes, each of which is assumed to be associated with a user. The data was anonymized so that particular data could not be matched to a particular user. All channel tune events for these users, indicating the channel the set-top box was tuned into and a time stamp were collected as implicit data. There were approximately 17,000 unique programs that aired during the four week period. The training data contained rᵤᵢ values, for each user u and program i, which represent how many times user u watched program i. Related is the number of minutes that a given show was watched. Analysis was focused on show length based units. The value of rᵤᵢ is a real value. The decimal portion, when present indicates that a user watched only a portion of the show. After aggregating multiple viewings of the same program, the number of non-zero rᵤᵢ values was about 32 million.

In addition to the training set of data, a similarly constructed test set of data was established based on all channel tune events during the single week following the four week training period. The training data was used to establish calculation constants and to allow a recommendation engine of a computer server (e.g., the recommendation engine 122 of the computer server 102 depicted in FIG. 1) that uses a factor model to generate predictions of what users would watch during the ensuing test week. The training period of 4 weeks was chosen based on an experimental study that showed that a shorter period tends to deteriorate the prediction results, while a longer period does not add much value. The lack of additional value may be because television schedules change seasonally and long training periods do not necessarily have an advantage. The method utilized by the recommendation engine is robust enough to avoid being contaminated by the seasonality. The observations in the test set are denoted by rᵤᵢ^{t} (distinguished with a superscript ^{t}).

One characteristic of television watching is the tendency to repetitively watch the same programs every week. It is much more valuable to a user to receive recommended programs that were not watched recently or that user is not aware of. Thus, for each user, the predictions from the test set corresponding to the shows that had been watched by that user during the training period are removed. To make the test set even more accurate, all entries with rᵤᵢ^{t}<0.5 are toggled to zero, as watching less than half of a program is not a strong indication that a user likes the program. This left about 2 million non-zero rᵤᵢ^{t} values in the test set.

The tendency to watch the same programs repeatedly also makes rᵤᵢ vary significantly over a large range. While there are a lot of viewing events close to 0 (e.g., due to channel flipping), 1, 2 or 3 (e.g., watching a film or a couple of episode of a series), there are also some viewing events that accumulate to hundreds (e.g., having a digital video recorder recording the same program for many hours per day over a period of 4 weeks). Due to the large range of values for rᵤᵢ, the log scaling scheme of Eq. 3 was used to calculate values of cᵤᵢ.

Another adjustment that was made concerned continuously watching the same channel. It is likely that the initial show that was tuned into was of interest to the viewer, while the subsequent shows were of decreasing interest. The television might simply have been left on while the viewer did something else or slept. Long spans of watching were considered due to a momentum effect. Programs watched due to momentum are less likely to reflect real preference. To overcome this effect, the second and subsequent shows after a channel tuning event are down-weighted. More specifically, for the t-th show after a channel tune, the following down-weighting factor is assigned:

$$\frac{{e}^{- ( at - b )}}{1 + {e}^{- ( at + b )}} \qquad ( Eq . 8 )$$

Experimental values for the constants a and b were determined to be 2 and 6, respectively. Applying the down-weighting factor reduces the rᵤᵢ by half for the third show after the channel tune, and for the fifth show without a change, the rᵤᵢ is reduced by 99%.

For each user, an ordered list of recommended shows was generated. The list was ordered from the one predicted to be most preferred to the one predicted to be least preferred. A portion of the list was presented to the user as the recommended shows. There was no reliable feedback regarding which programs were unloved, as not watching a program can stem from multiple different reasons. In addition, there was no way to track user reactions to the recommendations. Thus, precision based metrics were not appropriate, as they require knowing which programs are undesired to a user. However, watching a program is an indication of liking it, making recall-oriented measures applicable.

The variable rankᵤᵢ is used to denote the percentile-ranking of program i within the ordered list of all programs prepared for user u. This way, rankᵤᵢ=0% would mean that program is predicted to be the most desirable for user u, thus preceding all other programs in the list. On the other hand, rankᵤᵢ=100% indicates that program i is predicted to be the least preferred for user u, thus placed it at the end of the list. Percentile-ranks were used rather than absolute ranks in order to make the discussion general and independent of the number used in the recommendation engine. The basic quality measure is the expected percentile ranking of a watching unit in the test period, which is:

$$\overline{rank} = \frac{{\sum }_{u , i} {r}_{ui}^{t} {rank}_{ui}}{{\sum }_{u , i} {r}_{ui}^{t}} \qquad ( Eq . 9 )$$

Lower values of rank are more desirable, as they indicate ranking actually watched shows closer to the top of the recommendation lists. Notice that for random predictions, the expected value of rankᵤᵢ is 50% (placing i in the middle of the sorted list). Thus, r̅a̅n̅k̅>50% indicates an algorithm no better than random.

The recommendation engine was implemented using different numbers of latent factors (f), ranging from 10 to 200. In addition, calculations were performed using two other models for comparison purposes. The first model sorts all shows based on their popularity, so that the top recommended shows are the most popular ones. This naive measure is surprisingly powerful, as crowds tend to heavily concentrate on few of the many thousands of available shows. The value from this model is taken to be a baseline value. The second model is a neighborhood based (item-item) model based solely on the implicit data.

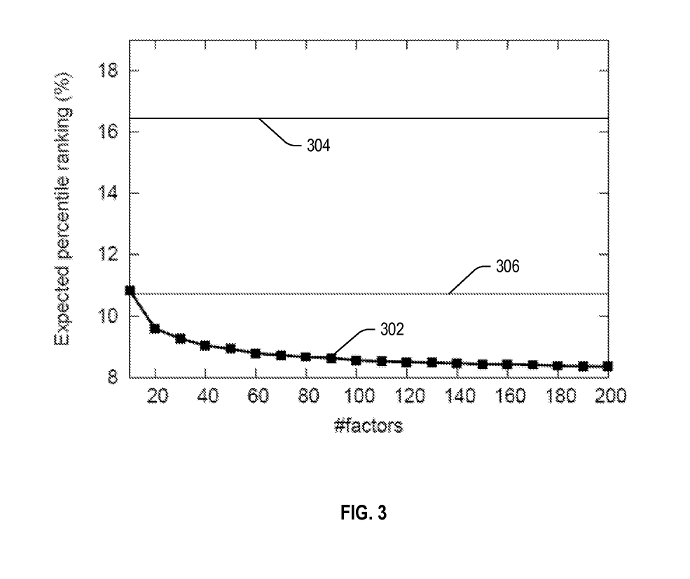

FIG. 3 shows the measured values of r̅a̅n̅k̅ with different number of latent factors from the recommendation engine as a curve 302. The results by the first model are presented as a first line 304, and the results of the second model are presented as a second line 306. The results based only on popularity (i.e., results from the first model) achieve a r̅a̅n̅k̅=16.46%, which is much lower than the r̅a̅n̅k̅=50% that would be achieved by a random predictor. However, a popularity based predictor is nonpersonalized and treats all users equally. The results of the neighborhood based method (i.e., results from the second model) offer an improvement ( r̅a̅n̅k̅=10.74%), achieved by personalizing recommendations. Even better results are obtained by the recommendation engine, which may offer a more principled approach to the problem. Results keep improving as number of latent factors increases, until r̅a̅n̅k̅=8.35% is reached for 200 latent factors. Thus, it is recommended that the highest number of latent factors feasible within computational limitations of the computer server be used.

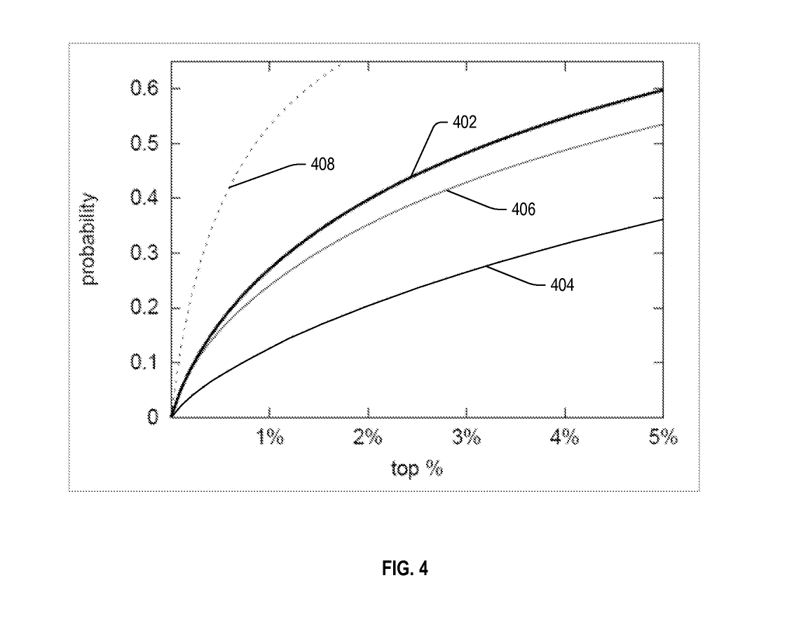

Further analysis of the quality of recommendations by the recommendation engine was performed by studying the cumulative distribution function of rankᵤᵢ. The recommendation engine was used with 100 latent factors, and the results were compared with the results of the popularity-based and the neighborhood-based techniques. The results are shown in FIG. 4. FIG. 4 answers the question: “What is the distribution of percentiles for the shows that were actually watched in the test set?” For a relatively successful model, most of the watched shows will have low percentiles. The results of the recommendation engine are presented as a first curve 402. The results of the first model are presented as a second curve 404. The results of the second model are presented as a third curve 406. From FIG. 4 it may be that a watched show is in the top 1% of the recommendations from the recommendation engine about 27% of the time. These results compare favorably to the second model, and are better than the results for the first model.

The results may be even better when all previously watched programs are left in the test set (i.e., without removing all user-program events that already occurred in the training period). Predicting re-watching of a program may be easier than predicting a first time view of a program. This is shown by a fourth curve 408 in FIG. 4, which does not remove all user-program events that already occurred in the training period. Although suggesting a previously watched show might not be very exciting, it may be useful. For example, the recommendation engine may inform users on which programs are running today that might interest them. Here, users may not be looking to be surprised with a new non-previously viewed program, but may be looking for a reminder of the programs that have been previously watched. The relatively higher predictive accuracy of retrieving previously watched shows may be beneficial for this task.

Also evaluated was the decision to transform the raw observations (the rᵤᵢ values), into distinct preference-confidence pairs (pᵤᵢ, cᵤᵢ). Other possible models were studied as well and compared to the results of the recommendation engine using 100 latent factors. The results of the recommendation engine were compared with the results from a regularized version of a Singular Value Decomposition (SVD) model that utilized rrᵤᵢ data. The SVD model consistently outperforms the popularity model, but the results were substantially poorer even than the neighborhood model. For example, for 50 latent factors yielded r̅a̅n̅k̅=13.63%, while 100 latent factors yield r̅a̅n̅k̅=13.40%. This relatively low quality is not surprising since taking rᵤᵢ as raw preferences may not be sensible.

A regularized SVD model that utilized only pᵤᵢ data without using confidence factors (i.e., all confidence factors are set to 1) was also examined. The results were better than the results of the SVD model that utilized rᵤᵢ data, leading to r̅a̅n̅k̅=10.72% with 50 latent factors and r̅a̅n̅k̅=10.49% with latent 100 factors. This is slightly better than the results achieved with the neighborhood model. However, this is still materially inferior to the results from the recommendation engine that takes into account both preference ratings and confidence ratings, which results in r̅a̅n̅k̅=8.93%-8.56% for 50-100 latent factors. The results indicate the benefits of using confidence ratings when determining recommendations.

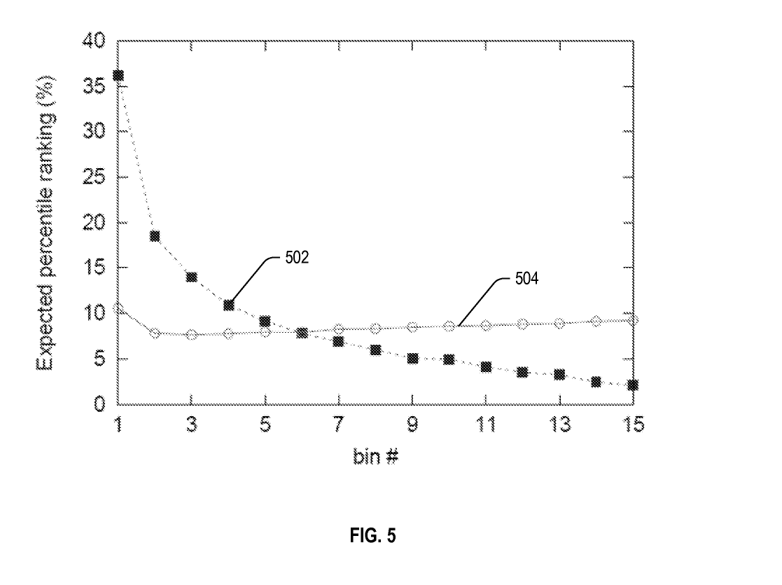

The performance of the recommendation engine (with 100 latent factors) was analyzed with respect to different types of shows and users. Different shows receive significantly varying watching time in the training data. Some shows are popular and watched a lot, while others are barely watched. The positive observations in the test set were split into 15 equal bins, based on increasing show popularity. The performance of the recommendation engine was measured for each bin, ranging from bin 1 (the least popular shows) to bin 15 (the most popular shows). The results are shown as a first curve 502 in FIG. 5. The first curve 502 shows that there is a gap in the accuracy of the recommendation engine when it becomes much easier to predict popular programs, and that is difficult to predict watching a non popular show. To some extent, the recommendation engine prefers to stay with the safe recommendations of familiar shows, on which it gathered enough data and can analyze well. This effect is not carried over to partitioning users according to their watching time.

The users are split into bins based on their overall watching times, with bin 1 representing users with the least amount of overall watching time and bin 15 representing users with the greatest amount of overall watching time. The results are shown as a second curve 504 in FIG. 5. Except for the first bin, which represents users with almost no watching history, the model performance is quite similar for all other user groups. This was somewhat unexpected, as experience with explicit feedback datasets predicts that prediction quality significantly increases as more information on users is gathered. An explanation of the unexpected behavior may be that the use activity attributed to a single user is actually the use of several users (e.g., several members of a family) who do not exhibit common preferences.

The recommendation list provided by the recommendation engine may include data that at least partially explains the reason why one or more items are in the recommendation list based on implicit observations associated with the user receiving the recommendation list. Table 1 shows three recommended shows for a particular user from the example. Eq. 6 was used to determine five other shows viewed by the user that influenced the choice of the recommended program and the total percentage that the five shows contributed to the decision to include the recommended program in the recommendation list. These explanations make sense: the reality show So You Think You Can Dance is explained by other reality shows, while Spider-Man is explained by other comic-related shows and Life in the E.R. is explained by medical documentaries. These common-sense explanations may help the user understand why certain shows are being recommended. In this case, the top five shows only explain between 35 and 40% of the recommendation, indicating that many other watched shows provide input to the recommendation engine.

TABLE 1

| | | | |
|---|---|---|---|
| Recommended | So You Think You Can | Spider-Man | Life in the E.R. |
| Program | Dance | | |
| Shows watched | Hell's Kitchen | Batman: The Series | Adoption Stories |
| by the user that | Access Hollywood | Superman: The Series | Deliver Me |
| influenced the | Judge Judy | Pinky and the Brain | Baby Diaries |
| recommendation | Moment of Truth | Power Rangers | I Lost It! |
| | Don't Forget the Lyrics | The Legend ofTarzan | Bringing Home Baby |
| % of | 36% | 40% | 35% |
| Recommendation | | | |

In multi-channel television environments, users often sort through a large variety of offered shows. Embodiments disclosed herein allow a particular user of a multi-channel television environment to use a recommendation engine to sort through the large variety of offered shows and provide personalized recommendations for programs based on implicit feedback data of the particular user and other users. The personalized recommendations should suit the tastes and watching habits of the particular user. The embodiments disclosed herein may be used to provide recommendations for other items in addition to television shows.

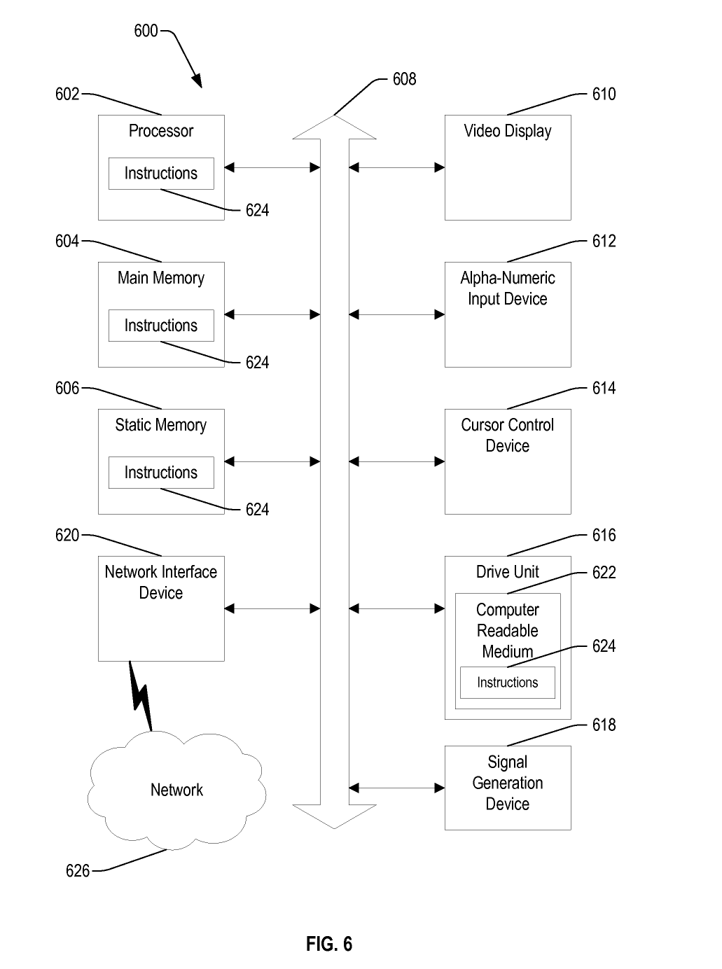

Referring to FIG. 6, an illustrative embodiment of a general computer system is shown and is designated 600. The computer system 600 may include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. For example, the computer system 600 may include or be included within one or more of the computer server 102, the set-top box device 106, the computer system 108, the mobile communication device 110, the implicit feedback database 124, the remote control device 144, and the display device 142 described with reference to FIG. 1.

In a networked deployment, the computer system 600 may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a web appliance, or any other machine capable of executing a set of instructions (sequential or otherwise) that specify actions to be taken by that machine. In a particular embodiment, the computer system 600 may be implemented using electronic devices that provide video, audio, or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 may include a main memory 604 and a static memory 606, which can communicate with each other via a bus 608. As shown, the computer system 600 may further include a video display unit 610, such as a liquid crystal display (LCD), a projection television system, a flat panel display, or a solid state display. Additionally, the computer system 600 may include an input device 612, such as a keyboard, and a cursor control device 614, such as a mouse. The computer system 600 may also include a disk drive unit 616, a signal generation device 618, such as a speaker or remote control, and a network interface device 620. Some computer systems 600 may not include an input device (e.g., a server may not include an input device).

In a particular embodiment, as depicted in FIG. 6, the disk drive unit 616 may include a computer-readable storage medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a computer-readable storage medium that stores instructions 624 or receives, stores and executes instructions 624 responsive to a propagated signal, so that a device connected to a network 626 may communicate voice, video or data over the network 626. Further, the instructions 624 may be transmitted or received over the network 626 via the network interface device 620.

While the computer-readable storage medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable storage medium may include a solid-state memory such as a memory card or other package that houses one or more non-volatile read-only memories. Further, the computer-readable storage medium may be a random access memory or other volatile re-writable memory. Additionally, the computer-readable storage medium may include a magneto-optical or optical medium, such as a disk or tapes or other storage device. Accordingly, the disclosure is considered to include any one or more of a computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
receiving, at a computing device, a request from a communication device of a first user for at least one recommendation;
accessing, at the computing device, data comprising a plurality of implicit feedback observations for a plurality of users, wherein the plurality of users includes the first user, and wherein each implicit feedback observation is associated with a particular user and a particular item of a plurality of items;
determining a plurality of preference ratings and a plurality of confidence ratings for each user of the plurality of users for each item based on the plurality of implicit feedback observations at the computing device;
generating a recommendation list of one or more of the plurality of items for the first user based on the plurality of preference ratings and the plurality of confidence ratings; and
sending the recommendation list to the communication device.

2. The method of claim 1, wherein the plurality of preference ratings and the plurality of confidence ratings are determined without consideration of explicit feedback observations.

3. The method of claim 1, wherein the plurality of implicit feedback observations includes quantifications of viewing patterns of one or more of the items of the plurality of items for each user of the plurality of users.

4. The method of claim 1, wherein the plurality of implicit feedback observations includes quantifications of searching patterns relevant to one or more of the items of the plurality of items for each user of the plurality of users.

5. The method of claim 1, wherein the plurality of implicit feedback observations includes quantifications of browsing history attributable to one or more of the items of the plurality of items for each user of the plurality of users.

6. The method of claim 1, wherein the plurality of implicit feedback observations includes quantifications of purchasing history attributable to one or more of the items of the plurality of items for each user of the plurality of users.

7. The method of claim 6, wherein the purchasing history includes rental activity and purchasing to own activity.

8. The method of claim 1, wherein the plurality of items comprises media content items.

9. The method of claim 8, wherein the plurality of implicit feedback observations includes indications of how long a selected user interacted with a selected item.

10. The method of claim 8, wherein the plurality of implicit feedback observations includes indications of how many separate times a selected user interacted with a selected item.

11. The method of claim 1, wherein the preference rating for a selected user and a selected item is set to one when there is a corresponding implicit feedback observation, and wherein the preference rating for the selected user and the selected item is set to zero when there is no corresponding implicit feedback observation.

12. The method of claim 1, wherein the recommendation list includes information directed to providing an explanation for inclusion of one or more of the items in the recommendation list.

13. The method of claim 1, wherein the plurality of confidence ratings include a default value for at least one item not having an associated implicit feedback observation, wherein the default value indicates a low confidence.

14. A computer device, comprising
a processor configured to receive a request via a communication device for at least one recommendation of an item for a first user associated with the communication device;
memory accessible to the processor, the memory including a recommendation engine, the recommendation engine executable by the processor to:
receive data comprising a plurality of implicit feedback observations, wherein each implicit feedback observation is associated with a user of a plurality of users and an item of a plurality of items, wherein the plurality of users includes the first user;
determine a plurality of preference ratings and a plurality of confidence ratings based on the plurality of implicit feedback observations; and
generate a recommendation list of one or more of the plurality of items for the first user based on the plurality of preference ratings and the plurality of confidence ratings.

15. The computer device of claim 14, wherein the communication device is a set-top box device, and wherein the items of the plurality of items comprise television programs.

16. The computer device of claim 15, wherein the processor is configured to send the recommendation list to the set-top box device, and wherein the set-top box device is configured to send the recommendation list to a display device coupled to the set-top box device.

17. The computer device of claim 14, wherein the communication device is a computer system coupled to the computer device via the internet.

18. The computer device of claim 14, wherein the plurality of feedback observations comprise explicit feedback observations.

19. A computer-readable storage medium comprising instructions, that when executed by a computer, cause the computer to:
receive data comprising a plurality of feedback observations, wherein each feedback observation is associated with a user of a plurality of users and an item of a plurality of items;
determine a plurality of preference ratings and a plurality of confidence ratings based on the plurality of feedback observations; and
generate a recommendation of one or more of the plurality of items with respect to a particular user based on the plurality of preference ratings and the plurality of confidence ratings.

20. The computer-readable storage medium of claim 19, wherein the preference rating of a selected item for a selected user indicates whether the selected user is aware of the selected item, and wherein the confidence rating is an indication that the preference rating of the selected item for the selected user is correct.
